(19) United States
(12) Patent Application Publication
(10) Pub. No.: US 2004/0075305 A1
(43) Pub. Date: Apr. 22, 2004

(54) Openable roof for a motor vehicle

(75) Inventors: Francois De Gaillard, Mouilleron en Pardes (FR); Martin De Waal, Assendelft (NL); Jean-Luc Guicheteau, Cholet (FR); Izumi Kimoto, Saeki-gun (JP); Michael Kolbl, Neuried (DE); Peter Mitterbauer, Gmunden (AT); Martin Pollak, Puchheim (DE); Claudio Ivano Righetti, Torino (IT); Miriam Schonauer, Garching (DE); Sigeru Ueki, Higashihiroshima-City (JP); Bernhard Vecchioni, Oxford, MI (US)

Correspondence Address: NIXON PEABODY, LLP, 401 9TH STREET, NW, SUITE 900, WASINGTON, DC, 20004-2128, US

(73) Assignee: WEBASTO VEHICLE SYSTEMS INTERNATIONAL GmbH, Stockdorf (DE)

(21) Appl. No.: 10/411,385

(22) Filed: Apr. 11, 2003

(30) Foreign Application Priority Data
Apr. 11, 2002 (DE) 102 15 969.6

(51) Int. Cl. B60J 7/043

(52) U.S. Cl. 296/216.02

(57) ABSTRACT

An openable roof for a motor vehicle having a driver's compartment (10) with a roof cover (12) which can be moved between a closed position and an open position, and a rear wall (14) that can be pivot with respect to the driver's compartment around an axis (24) which runs in the transverse direction of the vehicle, and with a cargo bed (16) which is located behind the driver's compartment. The roof cover (12) and the rear wall (14) are joined to one another to be able to fold in the manner of a hinge, the roof cover being folded in the open position onto the rear wall and the roof cover, and the rear wall being deposited in this position in the area of the cargo bed (16).

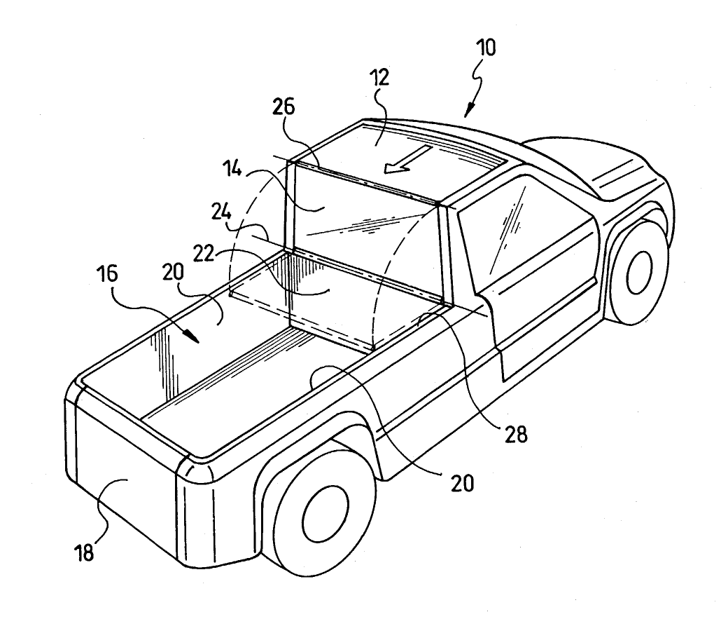

### BACKGROUND OF THE INVENTION

1. Field of the Invention

This invention relates to an openable roof for a motor vehicle having a driver's compartment with a roof cover which can be moved between a closed position and an open position, and a rear wall, the rear wall be pivotable with respect to the driver's compartment around an axis which runs in the transverse direction of the vehicle, and with a cargo bed which is located behind the driver's compartment.

2. Description of Related Art

A motor vehicle roof of the initially mentioned type is known, for example, from U.S. Pat. No. 5,098,148, where a pick-up truck is described in which the roof cover of the driver's compartment and the rear wall of the compartment which has the back window are rigidly joined to one another and as a unit, proceeding from the closed position in which the rear wall is oriented essentially vertically, is moved into the open position by means of a pivoting motion of roughly 180°. In the open position, the rear wall is vertically oriented, while the roof cover lies on the bottom of the cargo bed. Thus, the rear wall and the roof cover form an angle of 90° both in the closed position and also in the open position.

Similar vehicle roofs for pick-up trucks are known from U.S. Pat. Nos. 4,750,778, 4,805,956 and 5,906,408.

Additionally, U.S. Pat. No. 5,056,857 discloses a roof cover for the driver's compartment of a pick-up truck which can be moved from the closed position into a storage position in which it lies essentially vertically behind the driver's seat in a corresponding receiver.

### SUMMARY OF THE INVENTION

The primary object of this invention is to devise an openable roof for a motor vehicle with a driver's compartment and a cargo surface in which the roof cover and the rear wall are in the open position in as space-saving a manner as possible.

This object is achieved in accordance with the invention by an openable motor in which the roof cover and the rear wall are joined to one another to be able to fold in the manner of a hinge, the roof cover being folded in the open position onto the rear wall, and the roof cover and the rear wall being deposited in this position in the area of the cargo bed. This approach is advantageous in that the roof cover and the rear wall can be folded onto one another in the open position, and storage of the roof cover and the rear wall, in the open position, saves as much space as possible.

The invention is explained in detail below by way of example below using the accompanying drawings.

### BRIEF DESCRIPTION OF THE DRAWINGS

The sole FIGURE of the drawings is a schematic perspective of a vehicle with a roof in accordance with the invention.

### DETAILED DESCRIPTION OF THE INVENTION

According to the sole FIGURE, the driver's compartment 10 of a pick-up truck is provided with a roof cover 12 and a rear wall 14. Behind the driver's compartment 10 is a cargo bed 16 which is bordered by a rear wall 18, two side walls 20 and a front wall 22.

The rear wall 14 of the driver's compartment 10 is formed by a rear window which can be pivoted around a pivot axis 24 which runs in the transverse direction of the vehicle and which is located at the level of the top edge of the side walls 20 or the front wall 22 of the cargo bed 16. The rear wall 14 and the roof cover 12 are joined to one another by a hinge connection 26 so that the roof cover 12 can be folded or pivoted relative to the rear wall 14 around an axis 26 which runs in the transverse direction of the roof. The pivot axis 26 runs in the area of the back end of the roof cover 12.

Proceeding from the closed position which is shown in which the driver's compartment is closed to the top and bottom, the driver's compartment 10 can be cleared to the top and to the rear by the rear wall 14 being pivoted to the rear by roughly 90° around the pivot axis 24 in the manner indicated by the broken lines in the sole FIGURE, the roof cover 12 essentially retaining its horizontal orientation as a folding motion takes place at the same time between the rear wall 14 and the roof cover 12, so that, in the open end position, the roof cover 12 and the rear wall 14 are folded onto one another so as to be essentially parallel to one another. In this open position or lowered position, the rear wall 14 and the roof cover 12 lie on top of one another in an essentially horizontal alignment, and thus, lie at the level of the top edge 28 of the side walls 20 or the front wall 24 of the cargo surface 16.

What is claimed is:

1. Openable roof for a motor vehicle having a driver's compartment with a roof cover which can be moved between a closed position and an open position, and a rear wall, the rear wall be pivotable with respect to the driver's compartment around an axis which runs in the transverse direction of the vehicle, and with a cargo bed which is located behind the driver's compartment for a motor vehicle with a driver's compartment; wherein the roof cover and the rear wall are joined to one another to be able to fold in the manner of a hinge, the roof cover being folded onto the rear wall in the open position thereof, and the roof cover and the rear wall being deposited in the area of the cargo bed in the open position.

2. Motor vehicle roof as claimed in claim 1, wherein the rear wall comprises a rear window.

3. Motor vehicle roof as claimed in claim 1, wherein the rear wall and the roof cover are essentially horizontal in the open position.

4. Motor vehicle roof as claimed in claim 3, wherein the rear wall and the roof cover lie at the level of a top edge of side walls of the cargo bed in the open position.

5. Motor vehicle roof as claimed in preceding claim 1, wherein the rear wall and the roof cover form an angle of roughly 90° in the closed position.

6. Motor vehicle roof as claimed in claim 2, wherein the rear wall and the roof cover are essentially horizontal in the open position.

7. Motor vehicle roof as claimed in claim 6, wherein the rear wall and the roof cover lie at the level of a top edge of side walls of the cargo bed in the open position.

8. Motor vehicle roof as claimed in preceding claim 7, wherein the rear wall and the roof cover form an angle of roughly 90° in the closed position.
